(19) United States
(12) Patent Application Publication
(10) Pub. No.: US 2014/0234501 A1
(43) Pub. Date: Aug. 21, 2014

(54) METHOD AND APPARATUS FOR PRODUCING DRIED WHOLE EGG

(71) Applicant: Stanley Sant, Brantford (CA)

(72) Inventor: Stanley Sant, Brantford (CA)

(21) Appl. No.: 14/167,006

(22) Filed: Jan. 29, 2014

Related U.S. Application Data
(60) Provisional application No. 61/765,101, filed on Feb. 15, 2013.

(51) Int. Cl. A23L 1/32

(52) U.S. Cl. CPC A23L 1/3212
USPC 426/311; 426/614; 426/473

(57) ABSTRACT

The present concept is a method of producing dried whole egg, which includes the steps of de-shelling and separating the shell from the inner egg. Next the egg is cooked with live steam injection, and phosphoric acid is added. Next the cooked egg is dried. Finally the cooked egg is ground to a final particle size.

This application claims priority from previously filed U.S. provisional patent application No. 61/765,101 under the title METHOD AND APPARATUS FOR PRODUCING DRIED WHOLE EGG filed Feb. 15, 2013 by Stanley Sant.

### FIELD OF THE INVENTION

The present concept relates to producing dried foods and particularly relates to method and apparatus for producing dried whole egg.

### BACKGROUND OF THE INVENTION

In the egg processing industry eggs are sorted for fitness for human consumption and often due to external defects on the egg such as cracked shells or internal defects of the eggs such as double yolks these eggs are rejected for human consumption. The rejected eggs can be further processed for consumption by animals and this present concept describes a method and apparatus for producing dried whole egg for the consumption of animals.

There currently are a number of processes on the market which produce dried whole egg for the consumption of animals and the end product that is produced by these various processes varies greatly in quality and in its physical properties.

Often the dried whole egg is destined for inclusion into animal feed such as for use as a pet food ingredient. The consistency of the dried whole egg plays a very critical role in enabling the mixing of the dried whole egg into the entire feed mixture such as a pet food mixture.

Unfortunately the consistency and the physical properties of the dried whole egg end product which is currently available on the market often is of very fine flour like consistency which creates difficulty in the mixing of the dried whole egg with other ingredients found in pet food for example. It has been found that the morphology of the dried whole egg is very important in that it cannot be too fine to impede the mixing process and it must have physical properties which aid in the ability to mix thoroughly and evenly with other products which are found in animal feed such as pet food. Therefore there is a need for a dried whole egg product which has certain finished product characteristics and properties to be able to incorporate the dried whole egg into animal feed and into pet food packages.

### SUMMARY OF THE INVENTION

The present concept is a method of producing particulate de-shelled dried whole egg from raw eggs, comprising the steps of;
a) cooking the egg;
b) addition of phosphoric acid;
c) drying the cooked egg; and
d) grinding the cooked egg to a final particle size

Preferably further replacing step d) with d) grinding the cooked egg to a final particle size wherein 50% of the total mass has a particle size between 200 μm and 5000 μm.

Preferably further replacing step d) with d) grinding the cooked egg to a final particle size wherein 50% of the total mass has a particle size between 600 μm and 4000 μm.

Preferably further replacing step d) with d) grinding the cooked egg to a final particle size wherein less than 15% of the total mass has a particle size less than 150 μm.

Preferably further replacing step d) with d) grinding the cooked egg to a final size having a median particle size between 0.1 and 3.0 mm.

Preferably further replacing step d) with d) grinding the cooked egg to a final size having a median particle size between 0.5 and 2.0 mm.

Preferably further replacing step a) with a) cooking the egg with live steam injection.

Preferably further including the step of adding vitamin E.

Preferably further replacing step b) with b) adding phosphoric acid in the proportion from about 0.5 to 24 litres to 880 litres of cooked egg.

Preferably further replacing step b) with b) adding phosphoric acid in the proportion from about 1.0 to 12 litres to 880 litres of cooked egg.

Preferably further replacing step b) with b) adding phosphoric acid in the proportion from about 4 to 8 litres to 880 litres of cooked egg.

Preferably further including the step of adding vitamin E.

Preferably further replacing step c) with the steps of:
c′) dewatering the cooked egg;
c) drying the cooked egg; and

Preferably further replacing step c) with c) drying the cooked egg until the residual moisture content is about 10 wt % or less.

Preferably further replacing step c) with c) drying the cooked egg until the residual moisture content is about 5 wt % or less.

The present concept is a method of producing particulate whole dried whole egg, comprising the steps of:
a) de-shelling and separating the shell from the inner egg;
b) cooking the egg with live steam injection;
c) addition of phosphoric acid of about 6 litres for every 880 litres of cooked egg;
d) drying the cooked egg; and grinding the cooked egg to a final particle size wherein 50% of the total mass has a particle size>200 μm.

The present concept is a method of producing particulate de-shelled dried whole egg from raw eggs, comprising the steps of:
a) cooking the egg;
b) drying the cooked egg; and
c) grinding the cooked egg to a final particle size wherein less than 15% of the total mass has a particle size less than 150 μm

Preferably further replacing step c) with c) grinding the cooked egg to a final particle size wherein 50% of the total mass has a particle size between 250 μm and 5000 μm.

Preferably further replacing step c) with c) grinding the cooked egg to a final particle size wherein 50% of the total mass has a particle size between 600 μm and 4000 μm.

Preferably further replacing step c) with c) grinding the cooked egg to a final particle size wherein 50% of the total mass has a particle size>600 μm.

Preferably further replacing step c) with c) grinding the cooked egg to a final size having a median particle size between 0.1 and 3.0 mm.

Preferably further replacing step d) with d) grinding the cooked egg to a final size having a median particle size between 0.5 and 2.0 mm.

Preferably further replacing step b′) with b′) adding phosphoric acid in the proportion from about 0.5 to 24 litres to 880 litres of cooked egg.

Preferably further replacing step a) with the steps of:
a) cooking the egg;
b) addition of phosphoric acid

The method claimed in claim 1 further replacing step b) with b) adding phosphoric acid in the proportion from about 0.5 to 24 litres to 880 litres of cooked egg.

### BRIEF DESCRIPTION OF THE DRAWINGS

FIG. 1 is a schematic flow diagram of the material flow in a plant for producing dried whole egg.

FIG. 2 is a schematic floor plan view of a plant for producing dried whole egg.

FIG. 3A is a flow chart showing the steps in the production of dried whole egg.

FIG. 3B is a flow chart showing the steps in the production of dried whole egg.

FIG. 4 is a diagram showing the particles produced by the subject process.

FIG. 5 is a diagram showing the particles produced by prior art processes.

FIG. 6 is a diagram showing the particles produced by prior art processes.

FIG. 7 is a table of the particle size distribution of the subject product and process.

FIG. 8 is a bar chart of the particle size distribution of the subject products and process.

### DETAILED DESCRIPTION OF THE PREFERRED EMBODIMENTS

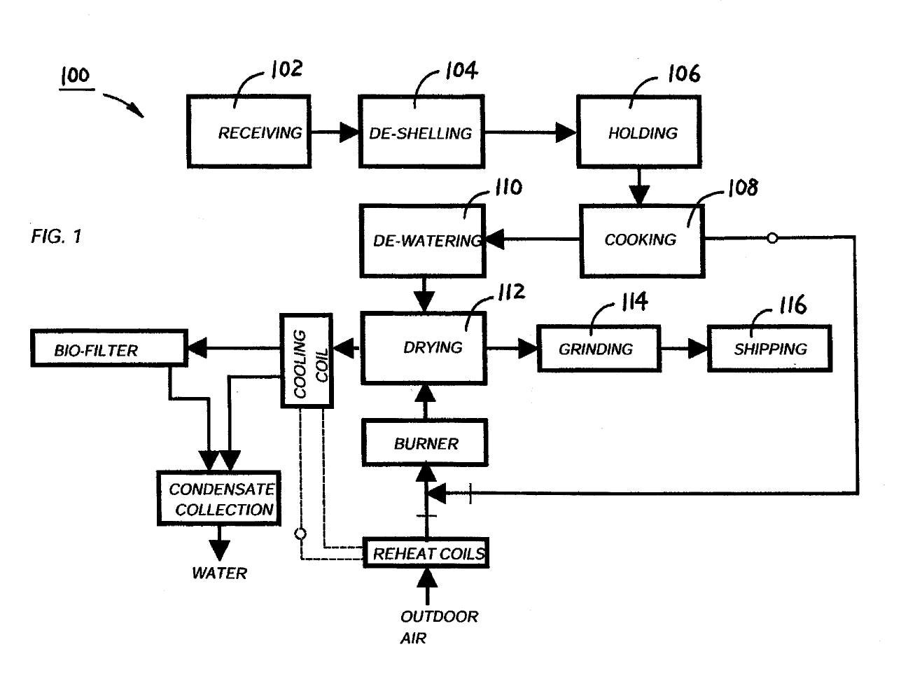

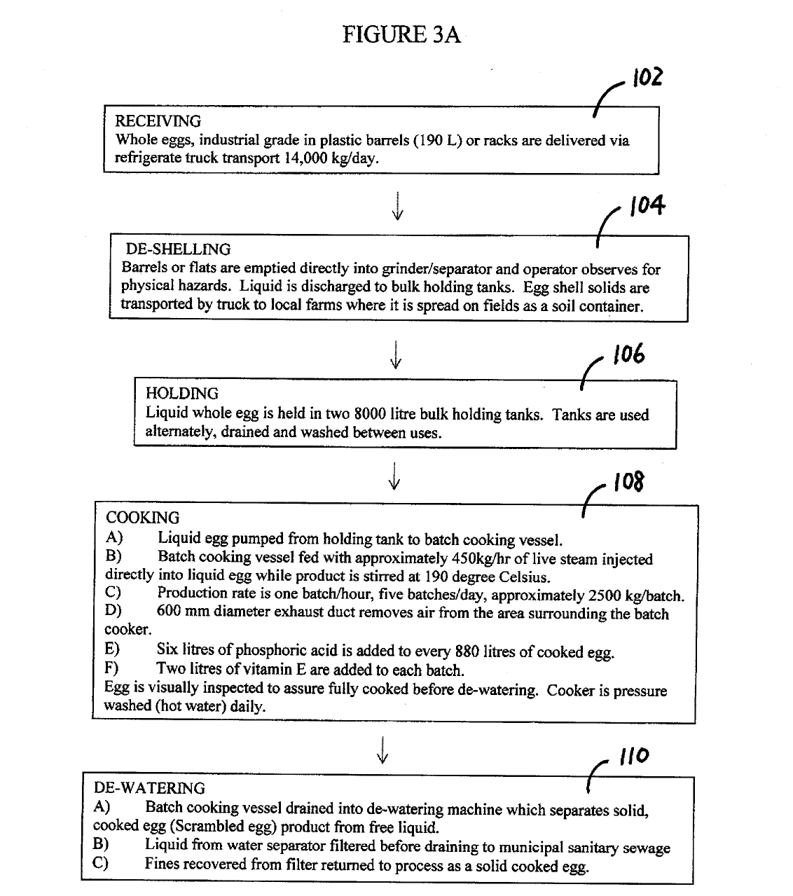

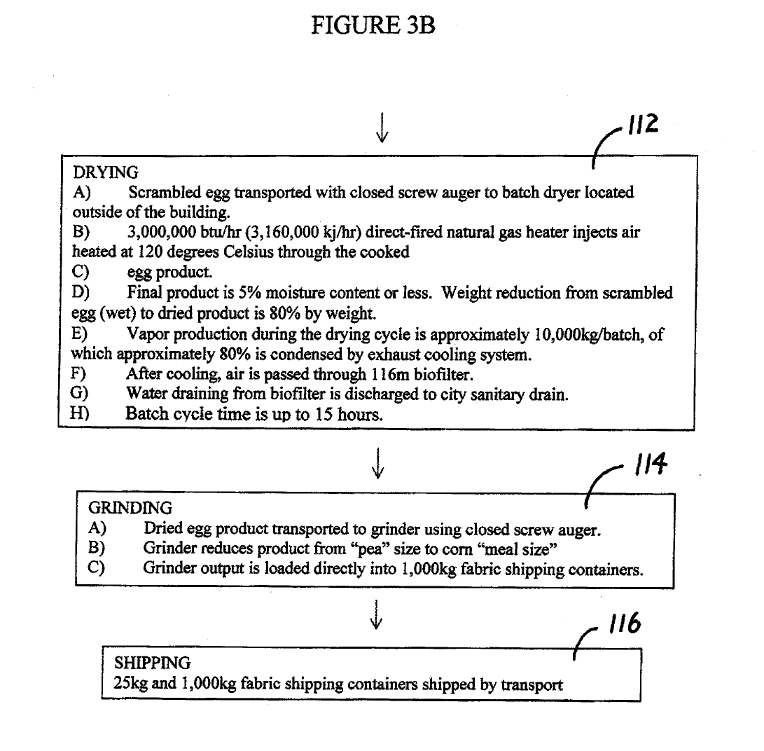

Referring to the attached figures the method to produce dried whole egg is shown in a flow diagram in FIG. 1 which shows the flow of materials in a method to produce dried whole egg 100. In addition FIGS. 3A and 3B in flowchart style show the steps involved in the method to produce dried whole egg.

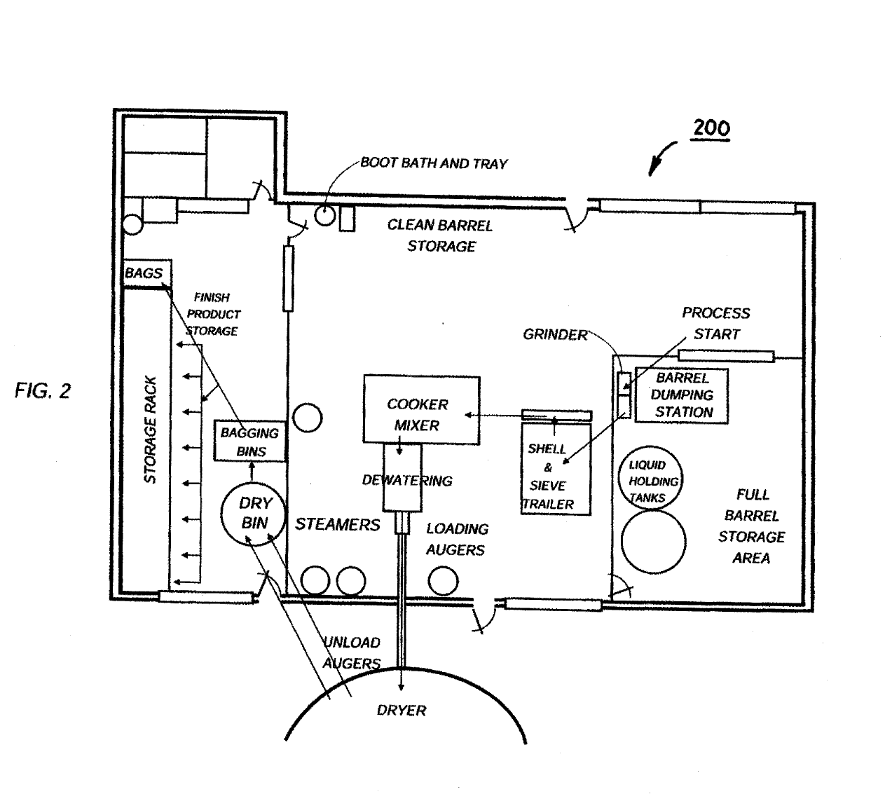

FIG. 2 is a schematic floor plan view of a plant showing the apparatus to produce dried whole egg 200.

Referring first of all to FIGS. 1 and 3A and 3B the following are the steps to a method to produce dried whole egg namely:

Step 1: Receiving; whole eggs, in industrial grade plastic barrels(190 L) or flats or racks and are delivered via refrigerate truck transport 14,000 kg/day denoted as 102.

De-Shelling

De-Shelling; barrels or flats are emptied directly into a grinder/separator and operator observes for physical hazards. Liquid is discharged to bulk holding tanks. Egg shell solids are transported by truck to local farms where it is spread on fields as a soil conditioner denoted as 104.

Holding

Step 3: Holding; Liquid whole egg is held in two 8000 litre bulk holding tanks. Tanks are used alternately, drained and washed between uses denoted as 106.

Cooking

### Step 4: Cooking;

a) Liquid egg is pumped from a holding tank to batch cooking vessel.
b) Batch cooking vessel fed with approximately 450 kg/hr of live steam injected directly into the liquid egg while product which is stirred at 190 degree Celsius.
c) Production rate is one batch/hour, five batches/day, approximately 2500 kg/batch.
d) 600 mm diameter exhaust duct removes air from the area surrounding the batch cooker.
e) Six litres of phosphoric acid is added to every 880 litres of cooked egg.
f) Two litres of vitamin E are added to each batch.
   Egg is visually inspected to assure fully cooked before de-watering. Cooker is pressure washed (hot water) daily as denoted in 108.

De-Watering

### Step 5: De-watering;

a) Batch cooking vessel is drained into a de-watering machine which separates solid, cooked egg (Scrambled egg) product from free liquid.
b) Liquid from water separator is filtered before draining to municipal sanitary sewage
c) Fines recovered from the filter are returned to the process as a solid cooked egg. As denoted in 110.

Drying

### Step 6: Drying;

a) Scrambled egg is transported with a closed screw auger to a batch dryer located outside of the building.
b) 3,000,000 btu/hr (3,160,000 kj/hr) direct-fired natural gas heater injects air heated at 120 degrees Celsius through the cooked egg product.
c) Final product is 5% moisture content or less. Weight reduction from scrambled egg (wet) to dried product is 80% by weight.
d) Vapor production during the drying cycle is approximately 10,000 kg/batch, of which approximately 80% is condensed by exhaust cooling system.
e) After cooling, air is passed through 116 m biofilter.
f) Water draining from biofilter is discharged to city sanitary drain.
g) Batch cycle time is up to 15 hours.
   As denoted in 112

Grinding

### Step 7: Grinding;

1) Dried egg product is transported to a grinder using a closed screw auger.
2) Grinder reduces product from “pea” size to corn “meal size”
3) Grinder output is loaded directly into 1,000 kg fabric shipping containers.
As denoted in 114

Shipping

Step 8: Shipping; 25 kg and 1,000 kg fabric shipping containers shipped by transport as denoted in 116.

The dried whole egg made by this method has a chemical composition as follows:
Protein—47% minimum
Fat—33% minimum
Ash—5% maximum
Moisture—5% maximum
Fibre—1% maximum

Referring now to FIG. 2 which is an apparatus to produce dried whole egg shown generally as 200. The process and equipment required in order to produce dried whole egg is described as follows:

Receiving

Whole eggs, industrial grade in plastic barrels (190 L) or racks are delivered via refrigerate truck transport 14,000 kg/day. Raw egg suppliers are all government approved grading stations. Drivers pick up raw product from cooler areas of suppliers, and check for secure lids, and properly skidded. Raw product is delivered promptly. Shown as 102

De-Shelling

Operator will sample random barrels for physical hazards and record findings on inspection check list, supervisor verification records with responsible signatures and comments. If hazards are found they will be removed at this stage. Barrels or flats are emptied into grinder/separator and operator observes for physical hazard and removes if present. The separator will catch any remaining physical hazards. Liquid is discharged to bulk holding tanks. Egg shell solids are transported by truck to local farms where it is spread on fields as a soil conditioner. Approximately 1,400 kg/day, shown as 104.

Holding

Liquid whole egg is held in two 8,000 litre bulk holding tanks. Tanks are used alternately, drained and washed between uses, shown as 106.

Cooking
a) Liquid egg pumped from holding tank to batch cooking vessel
b) Batch cooking vessel fed with approximately 450 kg/hr of live steam injected directly into liquid egg while product is stirred at 190 degrees Celsius
c) Production rate is one batch/hour, five batched/day, approximately 2,500 kg/batch
d) 600 mm diameter exhaust duct removes air from the area surrounding the batch cooker to the intake of the dryer heater at rates of up to 2.0 m³/s (4,200 cfm) according to the manual setting of the airflow dampers by the operator. Egg is visually inspected to assure fully cooked before de-watering. The cooker is pressure washed (hot water) daily. Shown as 108.

De-Watering
a) Batch cooking vessel drained into de-watering machine which separates solid, cooked egg (scrambled egg) product from free liquid
b) Liquid from water separator filtered before draining to municipal sanitary sewage
c) Fines recovered from filter returned to process as solid cooked egg
d) The effluent water has been tested and it has been determined that it is in compliance with effluent requirements
e) Operating schedule as per cooking process. Shown as 110

Drying
a) Scrambled egg transported with closed screw auger to batch dryer located outside of the building
b) 3,000,000 btu/hr (3,160,000 kj/hr) direct-fired natural gas heater injects air heated at 120 degrees Celsius through the cooked egg product.
c) Final product is 5% moisture content or less. Weight reduction from scrambled egg (wet) to dried product is 80% by weight
d) Vapour production during the drying cycle is approximately 10,000 kg/batch, of which approximately 80% is condensed by exhaust cooling system
e) After cooling, air is passed through 116 m² biofilter
f) Water draining from biofilter is discharged to city sanitary drain
g) Batch cycle time is up to 15 hours, shown as 112
h) Operating schedule is currently from 9:00 am to 12:00 pm 5 days/week
i) Current production rate is 1 batch/day or 2,500 kg of finished product
j) Temperature charter records drying process
k) Operator will spread cooked egg uniformly in the dryer after each cooking
l) A night check will occur by operator to check dryer and possibly spread egg uniformly. This check will create a negative temperature spike on the temperature charter and is acceptable for the control biological hazard
m) Calibration of the temperature Charter is performed annually maintaining records for 2 years

Grinding
a) Dried egg product transported to grinder using closed screw auger
b) Grinder reduces product from “pea” size to corn “meal size”
c) Grinder output is loaded directly into 1,000kg fabric shipping containers shown as 114
d) There are no air emissions from the grinding process
e) Pre-bagging routine, operator will change footwear after leaving unclean process area, wash hands and don lab coat reducing cross contamination.

Shipping 25 kg and 1,000 kg fabric shipping containers shipped by transport, shown as 116.

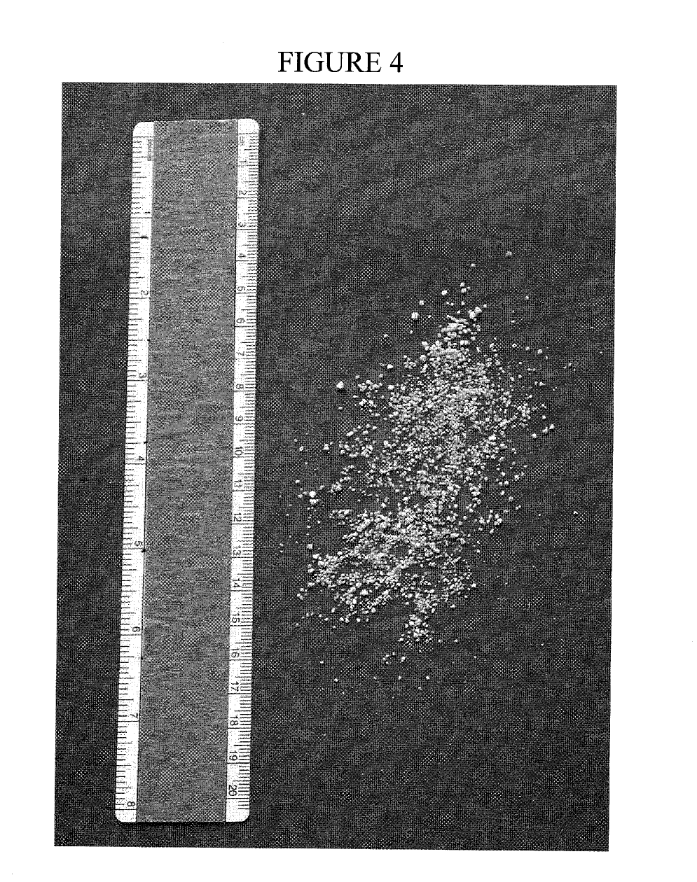

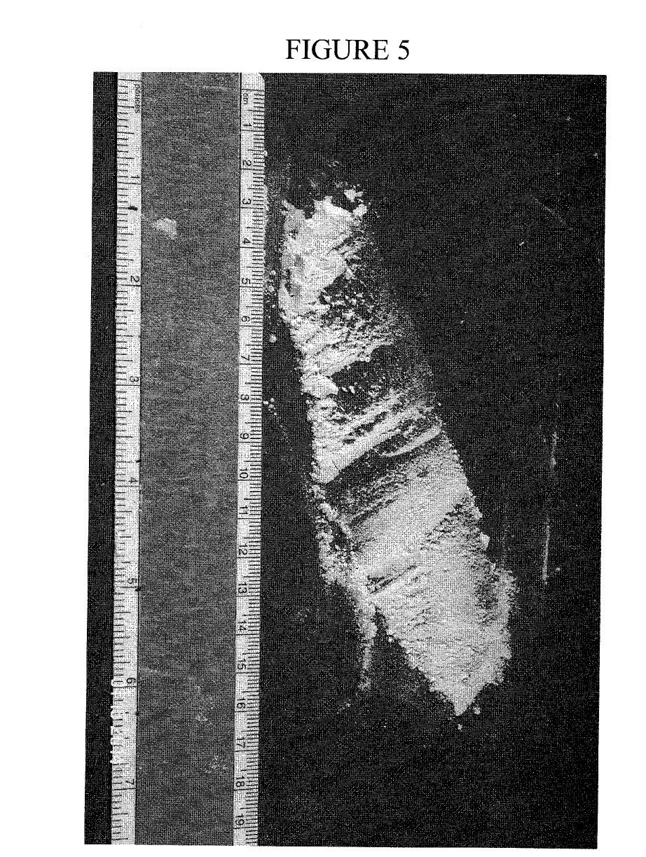

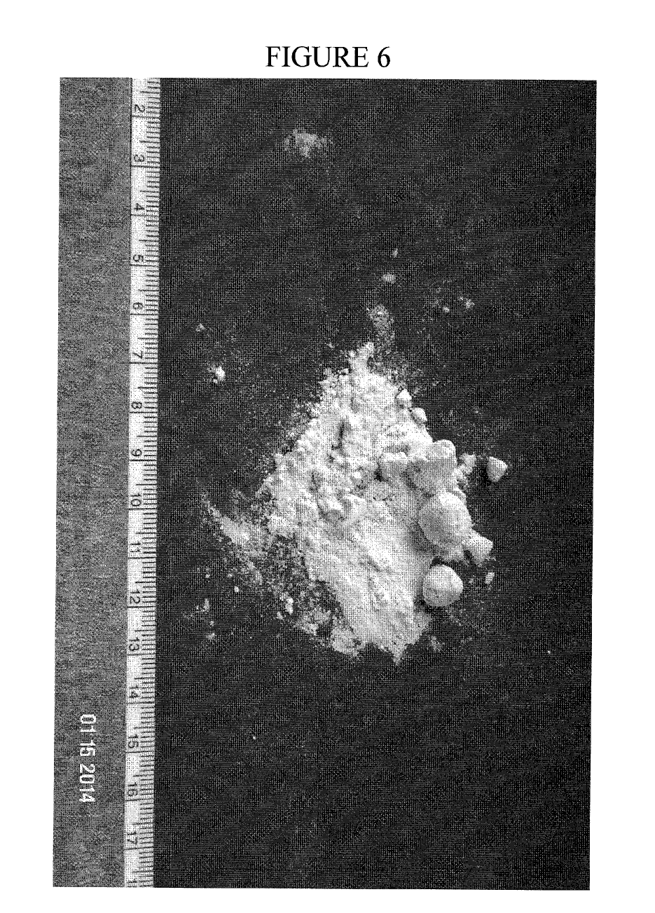

FIG. 4 is a photograph showing the particles that are produced by the subject process. The ruler is shown to give an idea of the scale and the reader will note that the particle size is significantly larger than the prior art particles which are shown in FIG. 5 and FIG. 6.

As indicated above unfortunately the consistency and the physical property of the dried whole egg end product which is currently available in the market and which has been photographed in FIGS. 5 and 6 is of a very fine flour like consistency which creates a great deal of difficulty in the mixing of the dried whole egg with other ingredients found in pet food for example.

The reader will note that in FIG. 6 that the prior art dried whole egg tends to clump and has a very sticky consistency as shown in FIG. 6 wherein one can see the clumps that have formed. The situation becomes even more difficult when one tries to mix the prior art dried whole egg that is currently available on the market having a very fine consistency as shown in FIGS. 5 and 6 with other ingredients. It is such a significant problem that machines tend to get clogged up due to clumping of product in the various mixing processes.

The inventor unexpectedly found that by producing a dried whole egg product having a particle size which looked more like that depicted in FIG. 4 provides for much easier mixing with other ingredients and also reduces the clumping of the material itself and the clumping of material when mixed with other materials.

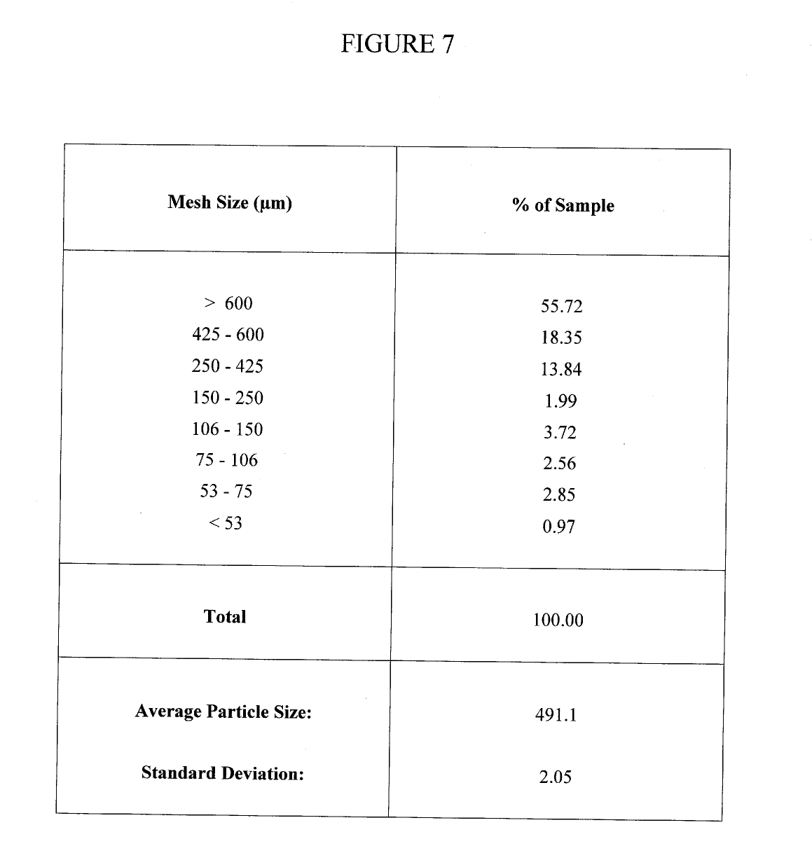

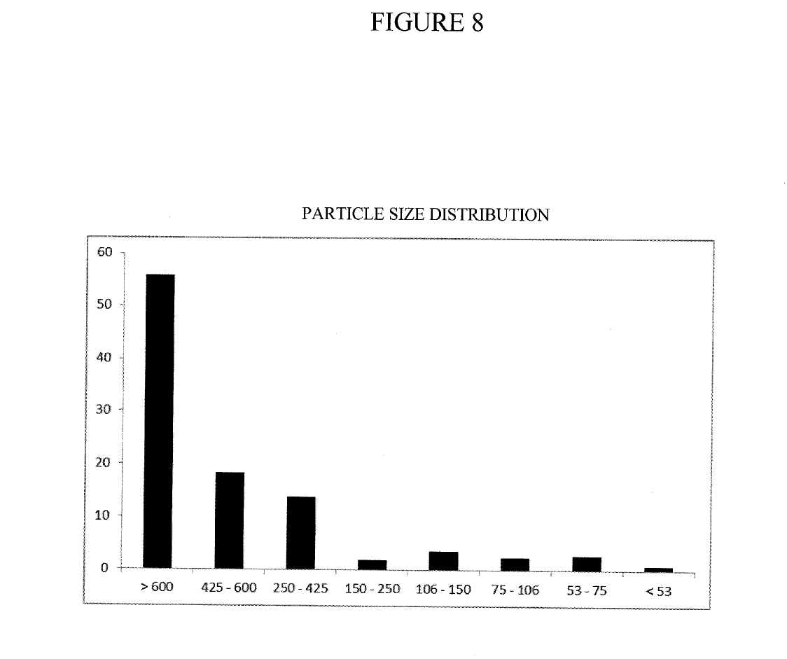

FIG. 7 is a table showing how particle size distribution of the presently developed dried whole egg product and FIG. 8 is a bar chart showing the particle size distribution of the presently produced product.

The reader will note that more than 50 percent of the particles have a particle size greater than 600 micrometres or 0.6 millimetres.

This is significantly larger than the present material on the market which has a particle size distribution similar to that of flour namely having a particle size from about 37 micrometres to 150 micrometres. In other words almost 100 percent of the existing material has a particle size lying between 37 micrometres and 150 micrometres.

The presently developed material has a particle size wherein more than 50 percent of the material has a particle size greater than 600 micrometres wherein the maximum particle size is about 5 mm. Additionally less than 15% of the particles are less than 150 micrometers in size. In this application we use the approximation that mesh size and particle size are approximately equivalent.

This large particle size is extremely beneficial to avoid clumping and to avoid clogging of mixing machines upon mixing of the dried whole egg end product with other products particularly when mixing together to create pet food.

Among other factors the addition of the phosphoric acid enables one to produce a particle that has a much less tendency to clump and clog upon mixing as compared to the current material available on the marketplace.

The inventor also determined that the final grinding operation is important to produce a larger particle size having a particle distribution as depicted in FIGS. 7 and 8 namely wherein more than 50 percent of the material has a particle size greater than 600 micrometres.

The inventor has also determined that provided that at least 50 percent of total mass of the particles is greater than 200 micrometres a very beneficial effect is obtained in that the clumping properties of the material having at least 50 percent material greater than 200 micrometres and less than 5 mm in size is improved compared to prior art material on the market however preferable anti clumping and clogging properties are exhibited when at least 50 percent by mass of the particles have a size greater than 600 micrometers and less than 4 mm.

The median particle size ranges from 0.2 to 3.0 mm with a preferred median particle size ranging from 0.5 to 2.0 mm.

It should be apparent to persons skilled in the arts that various modifications and adaptation of this structure described above are possible without departure from the spirit of the invention the scope of which defined in the appended claim.

I claim:

1) A method of producing particulate de-shelled dried whole egg from raw eggs, comprising the steps of;
a) cooking the egg;
b) addition of phosphoric acid;
c) drying the cooked egg; and
d) grinding the cooked egg to a final particle size.

2) The method claimed in claim 1 further replacing step d) with d) grinding the cooked egg to a final particle size wherein 50% of the total mass has a particle size between 200 μm and 5000 μm.

3) The method claimed in claim 1 further replacing step d) with d) grinding the cooked egg to a final particle size wherein 50% of the total mass has a particle size between 600 μm and 4000 μm.

4) The method claimed in claim 1 further replacing step d) with d) grinding the cooked egg to a final particle size wherein less than 15% of the total mass has a particle size less than 150 μm.

5) The method claimed in claim 1 further replacing step d) with d) grinding the cooked egg to a final size having a median particle size between 0.1 and 3.0 mm.

6) The method claimed in claim 1 further replacing step d) with d) grinding the cooked egg to a final size having a median particle size between 0.5 and 2.0 mm.

7) The method claimed in claim 1 further replacing step a) with a) cooking the egg with live steam injection;

8) The method claimed in claim 1 further including the step of adding vitamin E.

9) The method claimed in claim 1 further replacing step b) with b) adding phosphoric acid in the proportion from about 0.5 to 24 litres to 880 litres of cooked egg.

10) The method claimed in claim 1 further replacing step b) with b) adding phosphoric acid in the proportion from about 1.0 to 12 litres to 880 litres of cooked egg.

11) The method claimed in claim 1 further replacing step b) with b) adding phosphoric acid in the proportion from about 4 to 8 litres to 880 litres of cooked egg.

12) The method claimed in claim 1 further including the step of adding vitamin E.

13) The method claimed in claim 1 further replacing step c) with the steps of:
c′) dewatering the cooked egg;
c) drying the cooked egg; and

14) The method claimed in claim 1 further replacing step c) with c) drying the cooked egg until the residual moisture content is about 10 wt % or less.

15) The method claimed in claim 1 further replacing step c) with c) drying the cooked egg until the residual moisture content is about 5 wt % or less.

16) A method of producing particulate whole dried whole egg, comprising the steps of;
a) de-shelling and separating the shell from the inner egg;
b) cooking the egg with live steam injection;
c) addition of phosphoric acid of about 6 litres for every 880 litres of cooked egg;
d) drying the cooked egg; and
e) grinding the cooked egg to a final particle size wherein 50% of the total mass has a particle size>200 μm.

17) A method of producing particulate de-shelled dried whole egg from raw eggs, comprising the steps of;
a) cooking the egg;
b) drying the cooked egg; and
c) grinding the cooked egg to a final particle size wherein less than 15% of the total mass has a particle size less than 150 μm.

18) The method claimed in claim 17 further replacing step c) with c) grinding the cooked egg to a final particle size wherein 50% of the total mass has a particle size between 250 μm and 5000 μm.

19) The method claimed in claim 17 further replacing step c) with c) grinding the cooked egg to a final particle size wherein 50% of the total mass has a particle size between 600 μm and 4000 μm.

20) The method claimed in claim 17 further replacing step c) with c) grinding the cooked egg to a final particle size wherein 50% of the total mass has a particle size>600 μm.

21) The method claimed in claim 17 further replacing step c) with c) grinding the cooked egg to a final size having a median particle size between 0.1 and 3.0 mm.

22) The method claimed in claim 17 further replacing step d) with d) grinding the cooked egg to a final size having a median particle size between 0.5 and 2.0 mm.

23) The method claimed in claim 17 further replacing step b′) with b′) adding phosphoric acid in the proportion from about 0.5 to 24 litres to 880 litres of cooked egg.

24) The method claimed in claim 17 further replacing step a) with the steps of:
a) cooking the egg;
a′) addition of phosphoric acid;

25) The method claimed in claim 17 further replacing step b) with b) adding phosphoric acid in the proportion from about 0.5 to 24 litres to 880 litres of cooked egg.
